(19) United States
(12) Patent Application Publication
(10) Pub. No.: US 2023/0308521 A1
(43) Pub. Date: Sep. 28, 2023

(54) MANAGEMENT DEVICE, MANAGEMENT METHOD, AND RECORDING MEDIUM

(71) Applicant: NEC Corporation, Minato-ku, Tokyo (JP)

(72) Inventor: Ryo SHIBASAKI, Tokyo (JP)

(73) Assignee: NEC Corporation, Minato-ku, Tokyo (JP)

(21) Appl. No.: 18/020,132

(22) PCT Filed: Sep. 7, 2021
(86) PCT No.: PCT/JP2021/032863

§ 371 Date: Feb. 7, 2023

(30) Foreign Application Priority Data
Sep. 15, 2020 (JP) 2020-154496

(51) Int. Cl. H04L 67/55

(52) U.S. Cl. CPC H04L 67/55

(57) ABSTRACT

The message information items including, as attributes, a sender and multiple destinations, and having been sent in advance to one or more destinations among the multiple destinations after having been received from the sender, are temporarily stored. A correspondence is detected between a message information item sent from the sender to the one or more destinations and a message information item sent to the sender as a cancellation request from one destination among the one or more destinations. In the case in which a correspondence is detected between a message information item sent from the sender to the one or more destinations and the message information item sent to the sender as the cancellation request from the one destination among the one or more destinations, it is determined that the message information item sent from the sender to the one or more destinations is to be deleted.

### TECHNICAL FIELD

The present invention relates to a management device, a management method, and a recording medium for managing message information such as electronic mail.

### BACKGROUND ART

There is technology in which, after message information such as electronic mail has been sent to a destination, the sending of the message information that has already been sent is canceled. For example, paragraph [0046] in Patent Document 1 describes storing temporarily held mail in a held mail storage unit, and if the sender of that mail has sent an electronic mail serving as an instruction to delete the mail that is being temporarily held, then deleting that mail from the held mail storage unit.

### CITATION LIST

### Patent Literature

[Patent Document 1] Japanese Unexamined Patent Application, First Publication No. 2005-277976

### SUMMARY OF THE INVENTION

### Problems to be Solved by the Invention

There is demand for technology as mentioned above wherein the delivery of inappropriate electronic mail to a destination can be canceled without the need for a request from the sending user.

Therefore, an example objective of the present invention is to provide a management device, a management method, and a recording medium that solve the abovementioned problem.

### Means for Solving the Problems

According to an example of a first aspect of the present invention, a management device comprises temporary storing means for temporarily storing message information items including, as attributes, a sender and multiple destinations, the message information items having been sent in advance to one or more destinations among the multiple destinations after having been received from the sender; and verifying means for comparing the attributes of a message information item sent to the sender as a cancellation request from one destination among the one or more destinations with the attributes of multiple message information items that are temporarily stored by the temporary storing means to detect a correspondence between a message information item sent from the sender to the one or more destinations and the message information item sent to the sender as the cancellation request from the one destination among the one or more destinations, and in a case in which a correspondence is detected between a message information item sent from the sender to the one or more destinations and the message information item sent to the sender as the cancellation request from the one destination among the one or more destinations, determining that the message information item sent from the sender to the one or more destinations is to be deleted.

According to an example of a second aspect of the present invention, a management method includes storing temporarily message information items including, as attributes, a sender and multiple destinations, the message information items having been sent in advance to one or more destinations among the multiple destinations after having been received from the sender; and comparing the attributes of a message information item sent to the sender as a cancellation request from one destination among the one or more destinations with the attributes of multiple message information items that are temporarily stored to detect a correspondence between a message information item sent from the sender to the one or more destinations and the message information item sent to the sender as the cancellation request from the one destination among the one or more destinations, and in a case in which a correspondence is detected between a message information item sent from the sender to the one or more destinations and the message information item sent to the sender as the cancellation request from the one destination among the one or more destinations, determining that the message information item sent from the sender to the one or more destinations is to be deleted.

According to an example of a third aspect of the present invention, a recording medium has a program recorded therein, the program making a computer in a management device function as temporary storing means for temporarily storing message information items including, as attributes, a sender and multiple destinations, the message information items having been sent in advance to one or more destinations among the multiple destinations after having been received from the sender; and verifying means for comparing the attributes of a message information item sent to the sender as a cancellation request from one destination among the one or more destinations with the attributes of multiple message information items that are temporarily stored by the temporary storing means to detect a correspondence between a message information item sent from the sender to the one or more destinations and the message information item sent to the sender as the cancellation request from the one destination among the one or more destinations, and in a case in which a correspondence is detected between a message information item sent from the sender to the one or more destinations and the message information item sent to the sender as the cancellation request from the one destination among the one or more destinations, determining that the message information item sent from the sender to the one or more destinations is to be deleted.

### Advantageous Effects of Invention

According to the present invention, the delivery of inappropriate electronic mail to destinations can be canceled without the need for a request by the sending user.

### BRIEF DESCRIPTION OF THE DRAWINGS

FIG. 1 is a schematic configuration diagram of an electronic mail system according to an embodiment of the present invention.

FIG. 2 is a diagram depicting the hardware configuration of the management device according to an embodiment of the present invention.

FIG. 3 is a diagram depicting a functional block diagram of a management device according to an embodiment of the present invention.

FIG. 4 is a diagram depicting the processing flow in a management device according to an embodiment of the present invention.

FIG. 5 is a diagram depicting the minimum configuration of a management device according to an embodiment of the present invention.

FIG. 6 is a diagram depicting the processing flow according to a management device with the minimum configuration of the present invention.

### EXAMPLE EMBODIMENT

Hereinafter, an electronic mail system provided with a management device according to an embodiment of the present invention will be explained with reference to the drawings.

### First Embodiment

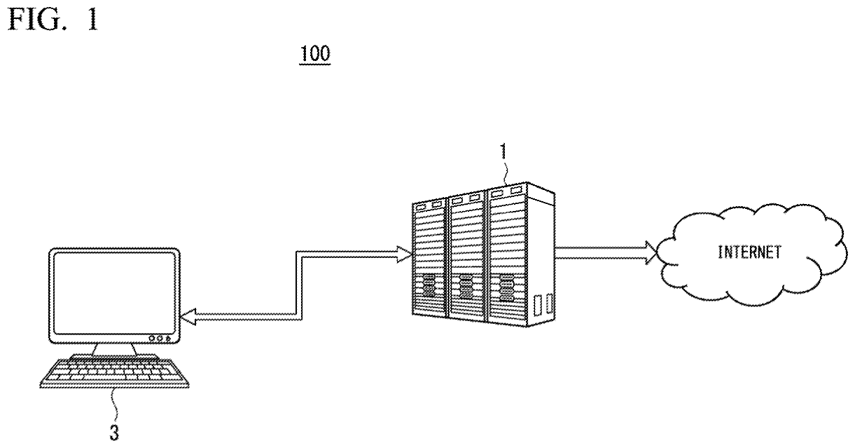

FIG. 1 is a schematic configuration diagram of an electronic mail system according to the present embodiment.

As illustrated in FIG. 1, an electronic mail system 100 is configured so as to include at least a management device 1. The management device 1 is connected, via a communication network, with a terminal 3 (client device) utilized by a user for sending electronic mail. The management device 1 and the terminal 3 transmit and receive information with respect to each other via the communication network by means of a communication protocol such as TCP (Transmission Control Protocol/IP (Internet Protocol). For convenience of explanation, only a single terminal 3 is illustrated in FIG. 1. However, the management device 1 is communicably connected with multiple terminals 3. The respective terminals 3 may be either the sources or the destinations of electronic mail. The management device 1 receives electronic mail received from the terminals 3. The management device 1 transfers electronic mail received from a terminal 3, for example, to another terminal (not illustrated) that is a destination via the internet.

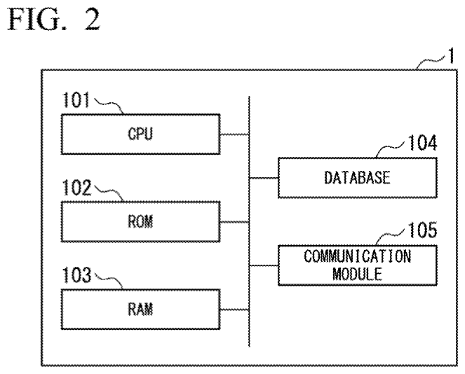

FIG. 2 is a diagram illustrating the hardware configuration of the management device.

As illustrated in FIG. 2, the management device 1 is a computer provided with hardware such as a CPU (Central Processing Unit) 101, a ROM (Read-Only Memory) 102, a RAM (Random Access Memory) 103, a database 104 (a storage device containing a database), and a communication module 105. The terminal 3 is also a computer provided with a similar hardware configuration.

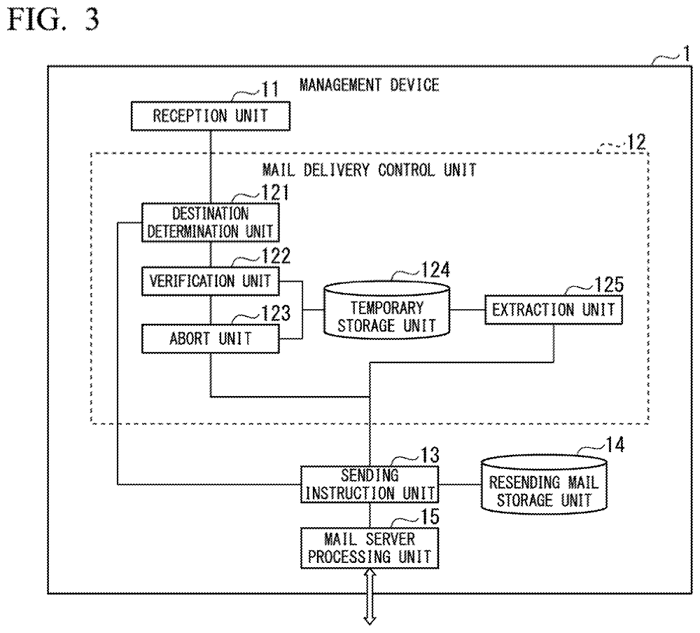

FIG. 3 is a diagram illustrating functional blocks of the management device.

The CPU 101 in the management device activates a mail delivery control program that is pre-stored in the management device 1. In this way, the management device 1 performs the respective functions of a reception unit 11, a mail delivery control unit 12, a sending instruction unit 13, a resending mail storage unit 14, and a mail server processing unit 15.

The reception unit 11 receives electronic mail from the terminal 3.

The mail delivery control unit 12 controls the delivery of the received electronic mail to the destinations.

Additionally, the mail delivery control unit 12 performs the respective functions of a destination determination unit 121, a verification unit 122, an abort unit 123, a temporary storage unit 124, and an extraction unit 125.

The destination determination unit 121 determines, based on multiple destinations indicated by attributes of an electronic mail received from a sender, whether or not affiliation groups of the destination users include an affiliation group not matching the affiliation group of the sending user. In the case in which, based on the multiple destinations indicated by the attributes of the electronic mail received from the sender, the affiliation groups of the destination users are determined to match the affiliation group of the sending user, the destination determination unit 121 determines that the electronic mail is to be immediately sent. In the case in which the affiliation groups of the destination users include both an affiliation group matching the affiliation group of the sending user and an affiliation group not matching the affiliation group of the sending user, the destination determination unit 121, based on the electronic mail received from the sender, respectively duplicates a first electronic mail for destination users affiliated with an affiliation group matching the affiliation group of the sending user, and a second electronic mail for destination users affiliated with affiliation groups not matching the affiliation group of the sending user, and determines that the first electronic mail is to be sent immediately and that the second electronic mail is to be stored in the temporary storage unit 124. The destination determination unit 121 refers to the multiple destinations indicated by the attributes of the electronic mail. In the case in which group attributes of groups with which the destination users are affiliated match a group attribute of the group with which the sender is affiliated, the destination determination unit 121 determines that the electronic mail is to be immediately delivered. In the case in which the group attributes of groups with which the destination users are affiliated do not match the group attribute of the group with which the sender is affiliated, then the destination determination unit 121 determines that processing is to be performed by the verification unit 122.

The verification unit 122 determines whether or not a received electronic mail is an electronic mail for which delivery is to be aborted. If the delivery is not to be aborted, then the verification unit 122 stores the received electronic mail in the temporary storage unit 124, and if the delivery is to be aborted, then the verification unit 122 makes a delivery abort process request.

In the case in which an electronic mail received by the verification unit 122 has been determined to be an electronic mail providing a notification of cancellation, then the abort unit 123 determines that the delivery of said electronic mail recorded in the temporary storage unit 124 is to be aborted, and generates an error mail for notifying the sender, etc. of said electronic mail that the delivery has been aborted.

The verification unit 122 stores, in the temporary storage unit 124, information regarding electronic mail, such as the main text of an electronic mail, envelope information for said electronic mail, and the sending date/time of said electronic mail. The stored information is deleted by the abort unit 123 in the case in which the sending of that electronic mail to the destination is aborted, or is deleted by the extraction unit 125 after that electronic mail has been sent to the destination.

The extraction unit 125 extracts, from the temporary storage unit 124, electronic mail for which a sending postponement period has elapsed, and resumes the mail delivery process. Although the timing at which the extraction process is performed is arbitrary, there are, for example, methods in which the extraction is performed periodically, and methods in which the extraction is performed when the sending postponement period has elapsed after the electronic mail was stored in the temporary storage unit 124.

The sending instruction unit 13 outputs, to the mail server processing unit 15, electronic mails extracted by the extraction unit 125 and error mails prepared by the abort unit 123. The sending instruction unit 13 performs a conventional mail delivery process in the case in which a temporary error or a permanent error has occurred during the sending process.

The resending mail storage unit 14 stores electronic mail for which delivery has temporarily failed in the sending instruction unit 13.

The mail server processing unit 15 uses known mail server functions to deliver the electronic mail.

Due to the respective functions mentioned above, the management device 1 temporarily stores, in the temporary storage unit 124, electronic mail including, as attributes, a sender and multiple destinations, wherein the electronic mail has been sent in advance to one or more destinations among the multiple destinations after having been received from the sender. The verification unit 122 compares the attributes of electronic mail sent to the sender as a cancellation request from one destination among the one or more destinations with the attributes of multiple electronic mails that are temporarily stored in the temporary storage unit 124. The verification unit 122 detects a correspondence between an electronic mail sent from the sender to the one or more destinations and the electronic mail sent to the sender as the cancellation request from one destination among the one or more destinations. In the case in which a correspondence is able to be detected between the electronic mail sent from the sender to the one or more destinations and the electronic mail sent to the sender as the cancellation request from one destination among the one or more destinations, the verification unit 122 determines that the electronic mail sent from the sender to the one or more destinations is to be cancelled.

In the processing in the management device 1 mentioned above, the destination determination unit 121 determines, based on the multiple destinations indicated by the attributes of the electronic mail received from the sender, whether the affiliation groups of the destination users include an affiliation group not matching the affiliation group of the sending user. Furthermore, in the case in which the affiliation groups of the multiple destination users indicated by the attributes of the electronic mail received from the sender include an affiliation group not matching the affiliation group of the sending user, the verification unit 122 records said electronic mail in the temporary storage unit 124.

Additionally, in the processing in the management device 1 mentioned above, in the case in which, based on the multiple destinations indicated by the attributes of the electronic mail received from the sender, the affiliation groups of those destination users match the affiliation group of the sending user, the destination determination unit 121 determines that said electronic mail is to be immediately sent.

Additionally, in the processing in the management device 1 mentioned above, the destination determination unit 121 determines whether or not the received electronic mail is an electronic mail that has been sent to the sender as a cancellation request from one destination among the multiple destinations. Furthermore, in the case in which the received electronic mail is an electronic mail that has been sent to the sender as the cancellation request from one destination among the multiple destinations, the verification unit 122 records the relevant electronic mail in the temporary storage unit 124.

Additionally, in the processing in the management device 1 mentioned above, the destination determination unit 121 determines, based on the multiple destinations indicated by the attributes of the electronic mail, whether the affiliation groups of the destination users include an affiliation group not matching the affiliation group of the sending user. In the case in which the affiliation groups of the destination users include both an affiliation group matching the affiliation group of the sending user and an affiliation group not matching the affiliation group of the sending user, the destination determination unit 121, based on the electronic mail, respectively duplicates a first electronic mail (first message information item) for destination users affiliated with the affiliation group matching the affiliation group of the sending user, and a second electronic mail (second message information item) for destination users affiliated with affiliation groups not matching the affiliation group of the sending user. The destination determination unit 121 determines that the first electronic mail is to be immediately sent, and determines that the second electronic mail is to be recorded in the temporary storage unit 124.

Additionally, in the processing in the management device 1 mentioned above, the extraction unit 125 extracts an electronic mail to be sent based on retention times, in the temporary storage unit 124, of multiple electronic mails stored in the temporary storage unit 124, and instructs that said electronic mail is to be sent.

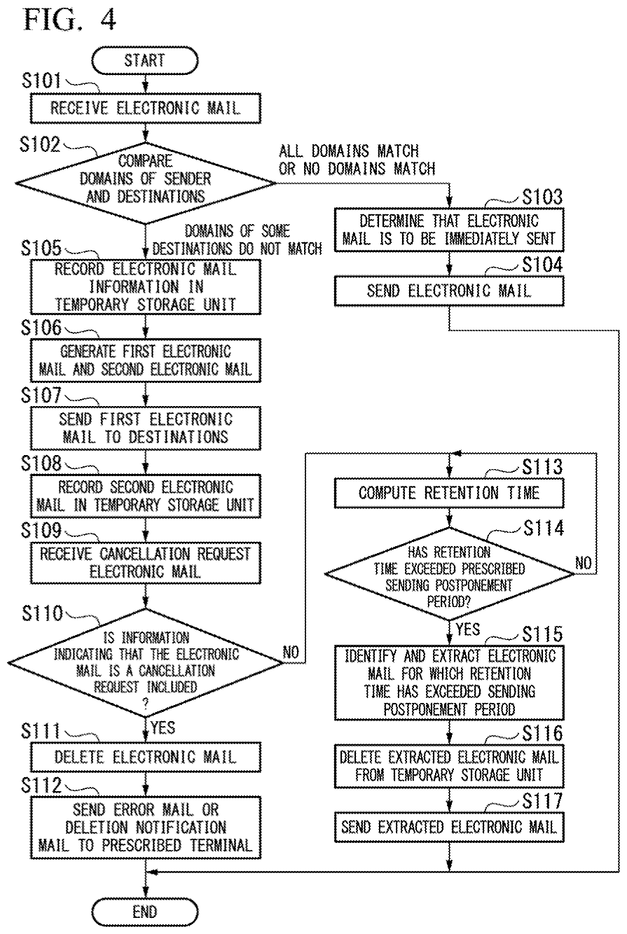

FIG. 4 is a diagram depicting the processing flow in the management device.

Next, the processing in the electronic mail system 100 including the management device 1 will be explained in accordance with the order thereof First, a terminal 3 sends an electronic mail based on operation of electronic mail software by a user. The electronic mail includes one or multiple items of destination information. Suppose that the terminal 3 has sent the electronic mail including the multiple items of destination information to the management device 1 with the terminal 3 as the sender. The reception unit 11 in the management device 1 receives the electronic mail (step S101). The destination determination unit 121 acquires the electronic mail from the reception unit 11.

The destination determination unit 121 acquires the sender address and the multiple destination addresses from the electronic mail. The destination determination unit 121 compares the domain indicated by the sender address with the domains indicated by the multiple destination addresses, and determines whether all of the domains indicated by the destination addresses match the domain indicated by the sender address, whether the domains indicated by some of the destination addresses match the domain indicated by the sender address, or whether none of the domains indicated by the destination addresses match the domain indicated by the sender address (step S102). This determination is an example of a process for determining, based on multiple destinations indicated by attributes of an electronic mail, whether or not the affiliation groups of the destination users include an affiliation group not matching the affiliation group of the sending user.

In the case in which the domain indicated by the sender address matches the domains indicated by all of the destination addresses, or none of the domains indicated by the destination addresses match the domain indicated by the sender address, the destination determination unit 121 determines that the electronic mail is to be sent to each of the destinations immediately (step S103). Furthermore, in the case in which the domain indicated by the sender address matches all of the domains indicated by the multiple destination addresses, or in the case in which none of the domains indicated by the destination addresses match the domain indicated by the sender address, the destination determination unit 121 outputs that electronic mail to the sending instruction unit 13. The sending instruction unit 13 outputs the electronic mail to the mail server processing unit 15. In this way, the mail server processing unit 15 sends the electronic mail to the destinations by means of known technology (step S104).

In the case in which the domain indicated by the sender address does not match the domains indicated by some of the destination addresses, the destination determination unit 121 determines that the affiliation groups of some of the destination users do not match the affiliation group of the sending user. In this case, the destination determination unit 121 outputs the electronic mail to the verification unit 122. The verification unit 122 records information regarding the electronic mail (the electronic mail, envelope information, sending date/time, etc.) in the temporary storage unit 124 (step S105).

In the case in which the domain indicated by the sender address matches the domains indicated by some of the destination addresses among the multiple destination addresses, and the domain indicated by the sender address does not match the domains indicated by other destination addresses, the destination determination unit 121 determines that the affiliation groups of the destination users include both an affiliation group matching the affiliation group of the sending user and an affiliation group not matching the affiliation group of the sending user. In this case, the destination determination unit 121 duplicates the acquired electronic mail or the like, thereby generating a first electronic mail destined for destination addresses in domains matching that of the sender address, and a second electronic mail destined for destination addresses in domains not matching that of the sender address (step S106). The destination determination unit 121 determines that the first electronic mail is to be immediately sent, and outputs the first electronic mail to the sending instruction unit 13. The destination determination unit 121 outputs the second electronic mail to the verification unit 122.

The sending instruction unit 13 outputs the first electronic mail to the mail server processing unit 15. In this way, the mail server processing unit 15 transmits the first electronic mail to the destinations by means of known technology (step S107). The verification unit 122 records information regarding the second electronic mail (the electronic mail, envelope information, sending date/time, etc.) to the temporary storage unit 124 (step S108).

According to the above-mentioned process, electronic mail is sorted between electronic mail to be sent to destinations immediately and electronic mail to be temporarily stored in the temporary storage unit 124. The electronic mail that is to be sent to the destinations immediately is electronic mail in which the affiliation groups of the destination users do not include affiliation groups that do not match the affiliation group of the sending user. In the case in which the affiliation groups of the destination users include affiliation groups not matching the affiliation group of the sending user, the management device 1 duplicates a first electronic mail and a second electronic mail, immediately sends only the first electronic mail, and records the second electronic mail in the temporary storage unit 124. In the case in which none of the affiliation groups of the multiple destination users match the affiliation group of the sending user, the management device 1 may record the electronic mail in the temporary storage unit 124 without duplication thereof.

According to the above-mentioned process, the management device 1 compares the domain indicated by the sender address of an electronic mail with the domains indicated by destination addresses, thereby determining whether or not the affiliation groups of the destination users include affiliation groups not matching the affiliation group of the sending user. However, the management device 1 may determine whether or not the affiliation groups of the destination users include affiliation groups not matching the affiliation group of the sending user by means of other processes. For example, the management device 1 may store a list of addresses associated with the domain indicated by the sender address. The management device 1 may determine that the affiliation groups match for destination addresses included in that address list, and may determine that the affiliation groups do not match for destination addresses not included in that address list. Additionally, the management device 1 may determine whether or not the affiliation groups of the destination users include affiliation groups not matching the affiliation group of the sending user by another method.

According to the above-mentioned process, electronic mail is immediately sent to destination users affiliated with the affiliation group of the sending user. A destination user utilizing a destination terminal that has received the electronic mail can utilize the destination terminal to return, to the sender terminal 3, electronic mail requesting cancellation. An example thereof is a destination user using a destination terminal to prepare a reply mail to a received electronic mail, inserting a simple text string, such as “abort” or “cancel”, in the subject line of the reply mail, and performing a reply operation. The destination terminal sends the cancellation request electronic mail (reply mail) to the sender terminal 3. Alternatively, the destination users may include, in the cancellation request electronic mail (reply mail), as information in an envelope TO of the cancellation request electronic mail, information indicating that the electronic mail is for requesting cancellation (information such as “cancel”).

In the case in which a destination user utilizing a destination terminal that has received an electronic mail has utilized that destination terminal to reply to the sender terminal 3 with a cancellation request electronic mail, the reception unit 11 in the management device 1 receives the cancellation request electronic mail (step S109). The destination determination unit 121 acquires the cancellation request electronic mail from the reception unit 11. The destination determination unit 121 acquires information on a subject line of the electronic mail, and determines whether or not the subject line includes information (text strings, etc.), such as “abort” or “cancel”, indicating that the electronic mail is for requesting cancellation (step S110).

Alternatively, the destination determination unit 121 may check whether mail address information written as an envelope TO of the received electronic mail is the same as mail address information written as an envelope TO in any of the electronic mails among those recorded in the temporary storage unit 124 to determine whether that electronic mail is a cancellation request electronic mail. In the case in which the mail address information written as the envelope TO of the received electronic mail is the same as mail address information written as the envelope TO of any electronic mail among the electronic mails stored in the temporary storage unit 124, the destination determination unit 121 determines that the received electronic mail is a cancellation request electronic mail.

In the case in which an acquired electronic mail has been determined to be a cancellation request electronic mail, the destination determination unit 121 outputs that electronic mail to the abort unit 123. The abort unit 123 acquires the cancellation request electronic mail.

Upon acquiring a cancellation request electronic mail, the abort unit 123 acquires an In-Reply-To header value for that cancellation request electronic mail. The abort unit 123 identifies, among the electronic mails stored in the temporary storage unit 124, an electronic mail holding a Message-Id header value matching the In-Reply-To header value of the cancellation request electronic mail. The abort unit 123 determines that, among the electronic mails stored in the temporary storage unit 124, an electronic mail holding a Message-Id header value matching the In-Reply-To header value in the cancellation request electronic mail is the electronic mail that is the subject of the cancellation request. The abort unit 123 deletes the electronic mail that is the subject of the cancellation request from the temporary storage unit 124 (step S111).

Due to this deletion process by the abort unit 123, an electronic mail for which there has been a cancellation request from a destination user affiliated with the affiliation group of the sending user, and which was temporarily stored in the temporary storage unit 124 to be sent to destination users in other affiliation groups not affiliated with the affiliation group of the sending user can be deleted in accordance with the intentions of a destination user affiliated with the affiliation group of the sending user. In the case in which an electronic mail that was erroneously sent by the sending user is checked by a destination user, affiliated with the affiliation group of the sending user, who realizes that the electronic mail was erroneously sent, that destination user can cancel the sending of the electronic mail that was erroneously sent by the sending user

Sending users, by similarly preparing and sending cancellation request electronic mails replying to the electronic mails sent by themselves, can similarly delete the electronic mails that were sent by themselves by means of the above-described process.

After deleting an electronic mail for which there has been a cancellation request, the abort unit 123 may prepare an error mail indicating that the deleted electronic mail was an error or a cancellation notification mail including information such as the subject line and the main text of the deleted electronic mail, and information such as the number deleted. The abort unit 123 may transmit an error mail or a deletion notification mail to the sender terminal 3 of the deleted electronic mail, or to another prescribed terminal. In this case, the abort unit 123 outputs the error mail or the deletion notification mail to the sending instruction unit 13. The sending instruction unit 13 instructs the mail server processing unit 15 to send the error mail or the deletion notification mail. The mail server processing unit 15 sends the error mail or the deletion notification mail to the prescribed terminal (step S112). As a result thereof, the sending user or another supervisor can check the error mail or the error notification mail and confirm that the electronic mail was erroneously sent.

The temporary storage unit 124 stores electronic mails that have been retained without being deleted by the abort unit 123. Furthermore, the extraction unit 125 acquires the sending dates/times and the storage dates/times of electronic mails stored in the temporary storage unit 124. The extraction unit 125 computes the retention times from the sending dates/times or storage dates/times until the current date/time (step S113). The extraction unit 125 determines whether or not the retention time of each electronic mail recorded in the temporary storage unit 124 has exceeded a prescribed sending postponement period (step S114). The extraction unit 125 identifies electronic mails for which the retention time has exceeded the sending postponement period among the respective electronic mails recorded in the temporary storage unit 124, and extracts the identified electronic mails from the temporary storage unit 124 (step S115). The extraction unit 125 outputs the extracted electronic mail to the sending instruction unit 13, and also deletes that electronic mail from the temporary storage unit 124 (step S116).

The sending instruction unit 13 instructs the mail server processing unit 15 to send the electronic mail acquired from the extraction unit 125. The mail server processing unit 15 sends the electronic mail extracted by the extraction unit 125 to the destinations (step S117). In this way, electronic mails retained in the temporary storage unit 124 without being deleted by the abort unit 123 are sent to their destinations. In this way, electronic mails that have temporarily been postponed from being sent can be sent to destination users affiliated with affiliation groups different from the affiliation group of the sending user.

The extraction unit 125 may periodically perform the above-mentioned process of extracting electronic mails that have been retained in the temporary storage unit 124 without being deleted by the abort unit 123 and determining whether or not they are to be sent.

In the case in which a temporary error or a permanent error has occurred in the sending of an electronic mail to the destinations, the mail server processing unit 15 may, during the above-mentioned process, temporarily store the electronic mail in a resending mail storage unit 14. Furthermore, the mail server processing unit 15 may periodically attempt to resend the electronic mail temporarily stored in the resending mail storage unit 14.

While an embodiment of the present invention has been explained above, according to the above-mentioned process, a third party who has detected an erroneously sent electronic mail affiliated with the affiliation group of the user who sent the electronic mail can abort the delivery of that electronic mail.

According to the above-mentioned process, since the delivery of the electronic mail can be aborted by replying to an electronic mail, there is no need to prepare a web browser or the like for the user to abort the delivery.

Additionally, according to the above-mentioned process, the delivery of electronic mail can be aborted by work that is conventionally performed, i.e., sending electronic mails. Thus, the user only needs to remember the address or the subject line of the electronic mail for aborting delivery. A mail address or a subject line that is easy to remember may be used by the user when sending the cancellation request electronic mail, such as using a mail address obtained by appending “cancel” or the like to the mail address conventionally used by that user, or using a subject line that is a text string obtained by appending “cancel” or “abort” to the subject line when transmitting the electronic mail to the mail address conventionally used by that user.

Additionally, according to the above-mentioned process, an error mail is sent to the sender when the sending of an electronic mail is aborted. Thus, mails for which delivery has been aborted can be identified.

### Second Embodiment

In the embodiment described above, a destination user affiliated with the affiliation group of the sending user can request cancellation of the electronic mail. However, a data table including the electronic mail addresses of electronic mail from destination users who can make cancellation requests may be held by the management device 1, and the management device 1 may accept only cancellation request electronic mails replying from electronic mail addresses recorded in this data table to delete, from the temporary storage unit 124, corresponding electronic mails to be cancelled based on the received cancellation request electronic mails. For example, the only users who are allowed to make cancellation requests may be superiors of the sending users, and pairs of electronic mail addresses of sending users and their superiors may be stored in the data table. Then, the verification unit 122 may delete an electronic mail recorded in the temporary storage unit 124 based on a cancellation request electronic mail sent from a superior's electronic mail address in the case in which a pair of the respective electronic mail addresses of the sending user and the superior is recorded in the data table.

### Third Embodiment

Additionally, in the embodiments described above, the destination determination unit 121 determines the affiliation group of the sending user and the affiliation groups of destination users by their domains. However, the destination determination unit 121 may determine the affiliation group of the sending user and the affiliation groups of the destination users based on a data table prepared regarding the respective affiliation groups.

### Fourth Embodiment

In the embodiment described above, the electronic mails recorded in the temporary storage unit 124 can be deleted by a destination user replying with a cancellation request electronic mail. However, the destination determination unit 121 in the management device 1 may store a URL (Uniform Resource Locator) for requesting cancellation in an electronic mail that it has determined should be immediately sent to the destinations, and that electronic mail may be sent. For example, by including a Message-Id header value of the electronic mail sent from the sender in the URL for requesting cancellation, an electronic mail for which delivery is to be aborted on the web server side can be uniquely decided.

More specifically, when a destination user affiliated with the affiliation group of the sending user checks an electronic mail and wishes to request cancellation, the destination user clicks a URL written into the main text of that electronic mail by processing in the destination determination unit 121 in the management device 1. This URL includes a Message-Id header value of the electronic mail sent from the sender. When the destination user clicks on this URL, the destination user terminal sends, to a prescribed web server, a cancellation request signal including the Message-Id header value. The web server acquires the Message-Id header value from the cancellation request signal. The web server determines whether or not the electronic mail including the Message-Id header value acquired from the cancellation request signal is recorded in the temporary storage unit 124. In the case in which the electronic mail including the Message-Id header value acquired from the cancellation request signal is recorded in the temporary storage unit 124, the web server identifies that electronic mail and deletes the electronic mail.

### Fifth Embodiment

In the embodiments described above, examples for the case in which the message information items are electronic mail, the management device 1 is included in an electronic mail system 100, and the delivery of electronic mail is managed were explained. However, the management device 1 may be included in a message information delivery system that delivers message information items other than electronic mail, and message information items other than electronic mail may be delivered.

In this case, the management device 1 receives a message information item from the terminal 3. Furthermore, as in the respective embodiments described above, the management device 1 immediately delivers the message information item to destinations, or duplicates the message information item to generate a first message information item and a second message information item, delivers the first message information item to the destinations, and stores the second message information item in the temporary storage unit 124. Then, the management device 1 that has received a cancellation request message information item from the sender of the first message information item may delete the temporarily stored second message information without sending it to the destinations. In this way, in the case in which, based on multiple destinations indicated by the attributes of the message information item received from the sender, an affiliation group of the destination users has been determined as not matching the affiliation group of the sending user, the management device 1 does not deliver the generated second message information item. Therefore, the management device 1 can stop the delivery of the message information item to destinations affiliated with affiliation groups not matching the affiliation group of the sending user, based on a request from another user affiliated with an affiliation group matching the affiliation group of the sending user.

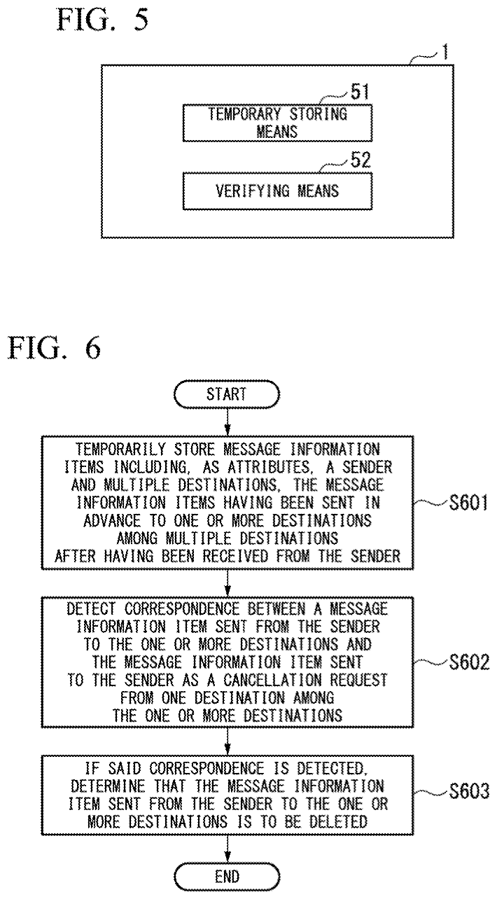

FIG. 5 is a diagram depicting the minimum configuration of the management device.

FIG. 6 is a diagram depicting the processing flow according to the management device with the minimum configuration.

The management device 1 only needs to be provided with at least a temporary storing means 51 and a verifying means 52.

The temporary storing means 51 temporarily stores message information items including, as attributes, a sender and multiple destinations, the message information items having been sent in advance to one or more destinations among multiple destinations after having been received from the sender (step S601).

The verifying means 52 compares the attributes of a message information item sent to the sender as a cancellation request from one destination among the one or more destinations with the attributes of multiple message information items that are temporarily stored to detect a correspondence between a message information item sent from the sender to the one or more destinations and the message information item sent to the sender as a cancellation request from the one destination among the one or more destinations (step S602).

In the case in which a correspondence is detected between a message information item sent from the sender to the one or more destinations and the message information item sent to the sender as a cancellation request from the one destination among the one or more destinations, the verifying means 52 determines that the message information item temporarily stored as the message information item to be sent from the sender to the plurality of destinations is to be deleted (step S603).

Each of the above-mentioned devices may have an internal computer system. Furthermore, the steps in the respective above-mentioned processes are stored, in the form of a program, in a computer-readable storage medium, and the above-mentioned processes are performed by this program being read out and executed by a computer. In this case, the computer-readable recording medium refers to magnetic discs, magneto-optic discs, CD (Compact Disc)-ROMs, DVD (Digital Versatile Disc)-ROMs, semiconductor memory, etc. Additionally, the computer program may be distributed to a computer by a communication line, and the computer that has received this distribution may execute said program.

Additionally, the above-mentioned program may be for realizing just some of the aforementioned functions. Furthermore, the above-mentioned program may be able to realize the aforementioned functions by being combined with a program already recorded in a computer system, i.e., the program may be a so-called difference file (difference program).

While the present invention has been explained by referring to the embodiments above, the present invention is not limited to the above-mentioned embodiments. Various changes that would be understood by a person skilled in the art can be made to the configuration and details of the present invention within the scope of the present invention.

The present application claims priority on the basis of Japanese Patent Application No. 2020-154496, filed Sep. 15, 2020, the entire disclosure of which is incorporated herein by reference.

### INDUSTRIAL APPLICABILITY

The present invention can be applied to the management of electronic mail.

### REFERENCE SIGNS LIST

1 Management device
3 Terminal
11 Reception unit
12 Mail delivery control unit
13 Sending instruction unit
14 Resending mail storage unit
Mail server processing unit
121 Destination determination unit (destination determining means)
122 Verification unit (verifying means)
123 Abort unit
124 Temporary storage unit (temporary storing means)
125 Extraction unit (extracting means)
100 Electronic mail system

What is claimed is:

1. A management device comprising:
at least one memory configured to store instructions, and store temporarily message information items including, as attributes, a sender and multiple destinations, the message information items having been sent in advance to one or more destinations among the multiple destinations after having been received from the sender; and
at least one processor configured to execute the instructions to:
compare the attributes of a message information item sent to the sender as a cancellation request from one destination among the one or more destinations with the attributes of multiple message information items that are temporarily stored by the at least one memory to detect a correspondence between a message information item sent from the sender to the one or more destinations and the message information item sent to the sender as the cancellation request from the one destination among the one or more destinations; and
determine, in a case in which a correspondence is detected between a message information item sent from the sender to the one or more destinations and the message information item sent to the sender as the cancellation request from the one destination among the one or more destinations, that the message information item sent from the sender to the one or more destinations is to be deleted.

2. The management device according to claim 1,
wherein the at least one processor is further configured to execute the instructions to:
determine, based on the multiple destinations indicated by the attributes of the message information item received from the sender, whether affiliation groups of users of the multiple destinations include an affiliation group not matching an affiliation group of the user who is the sender; and
record in the at least one memory, in a case in which the affiliation groups of the users of the multiple destinations indicated by the attributes of the message information item received from the sender include an affiliation group not matching the affiliation group of the user who is the sender, the message information item that has been received from the sender.

3. The management device according to claim 2,
wherein the at least one processor is configured to execute the instructions to:
determine, in a case in which, based on the multiple destinations indicated by the attributes of the message information item received from the sender, the affiliation groups of the users of the multiple destinations are determined to match the affiliation group of the user who is the sender, that the message information item received from the sender is be immediately sent.

4. The management device according to claim 2,
wherein the at least one processor is configured to execute the instructions to:
determine whether a message information item that has been received is a message information item sent to the sender as the cancellation request from one destination among the one or more destinations; and
record in the at least one memory, in a case in which the message information item that has been received is a message information item sent to the sender as the cancellation request from one destination among the one or more destinations, the message information item that has been received.

5. The management device according to claim 2,
wherein the at least one processor is configured to execute the instructions to:
duplicate based on the message information item received from the sender, in a case in which the affiliation groups of the users of the multiple destinations include both an affiliation group matching the affiliation group of the user who is the sender and an affiliation group not matching the affiliation group of the user who is the sender, a first message information item for a user at a destination affiliated with the affiliation group matching the affiliation group of the user who is the sender, and a second message information item for a user at a destination affiliated with an affiliation group not matching the affiliation group of the user who is the sender; and
determine that the first message information item is to be immediately sent and that the second information item is to be recorded in the at least one memory.

6. The management device according to claim 1,
wherein the at least one processor is further configured to execute the instructions to:
extract a message information item to be sent based on retention times, in the at least one memory, of the multiple message information items that are temporarily stored, and instructing that the message information item that has been extracted is to be sent.

7. The management device according to claim 1 wherein the message information items are electronic mail.

8. A management method comprising:
storing temporarily message information items including, as attributes, a sender and multiple destinations, the message information items having been sent in advance to one or more destinations among the multiple destinations after having been received from the sender;
comparing the attributes of a message information item sent to the sender as a cancellation request from one destination among the one or more destinations with the attributes of multiple message information items that are temporarily stored to detect a correspondence between a message information item sent from the sender to the one or more destinations and the message information item sent to the sender as the cancellation request from the one destination among the one or more destinations; and
determining, in a case in which a correspondence is detected between a message information item sent from the sender to the one or more destinations and the message information item sent to the sender as the cancellation request from the one destination among the one or more destinations, that the message information item sent from the sender to the one or more destinations is to be deleted.

9. A non-transitory computer-readable recording medium recording a program that causes a management device to perform processes, the processes comprising:
storing temporarily message information items including, as attributes, a sender and multiple destinations, the message information items having been sent in advance to one or more destinations among the multiple destinations after having been received from the sender;
comparing the attributes of a message information item sent to the sender as a cancellation request from one destination among the one or more destinations with the attributes of multiple message information items that are temporarily stored to detect a correspondence between a message information item sent from the sender to the one or more destinations and the message information item sent to the sender as the cancellation request from the one destination among the one or more destinations; and
determining, in a case in which a correspondence is detected between a message information item sent from the sender to the one or more destinations and the message information item sent to the sender as the cancellation request from the one destination among the one or more destinations, that the message information item sent from the sender to the one or more destinations is to be deleted.
